(19) United States
(12) Patent Application Publication
(10) Pub. No.: US 2024/0088454 A1
(43) Pub. Date: Mar. 14, 2024

(54) Method for Producing an Electrical Energy Store, and Electrical Energy Store

(71) Applicant: Bayerische Motoren Werke Aktiengesellschaft, Muenchen (DE)

(72) Inventors: Martin HILLER, Karlsfeld (DE); Cornelius HUPBAUER, Muenchen (DE); Matthias SCHROEDER, Muenchen (DE)

(21) Appl. No.: 18/272,828

(22) PCT Filed: Dec. 21, 2021
(86) PCT No.: PCT/EP2021/086980

§ 371 Date: Jul. 18, 2023

(30) Foreign Application Priority Data
Jan. 19, 2021 (DE) 10 2021 101 053.5

(51) Int. Cl. H01M 10/42; H01M 10/04; H01M 10/058; H01M 10/44; H01M 50/103; H01M 50/107

(52) U.S. Cl. CPC H01M 10/4235; H01M 10/049; H01M 10/058; H01M 10/446; H01M 50/103; H01M 50/107

(57) ABSTRACT

A method for producing an electrical energy store is provided, including providing a housing, at least one positive electrode, which includes a first active material, and at least one negative electrode, which includes a second active material, which are inserted into the housing. Then, a gas mixture is metered into an empty volume of the housing, and the housing is sealed in a gas-tight manner. The gas mixture includes at least one gas component which is at least partially reacted with at least one of the first active material and the second active material after the housing has been sealed. An electrical energy store is also provided.

### BACKGROUND AND SUMMARY OF THE INVENTION

The invention relates to a method for producing an electrical energy store and also to an electrical energy store.

An electrical energy store is an electrochemically based energy store which is rechargeable and is adapted to storing electrical energy and providing it to consumer units, more particularly consumer units in a vehicle.

During the operation of an electrical energy store, secondary reactions of the components of the electrical energy store may result in formation of gases, as a result, for example, of the partial decomposition—due to evolution of heat—of an electrolyte used in the electrical energy store. Over the lifetime of the electrical energy store, therefore, an overpressure may build up within a housing of the electrical energy store, and may reduce the performance and also the maximum lifetime of the electrical energy store.

In order to prevent an excessive overpressure building up within an electrical energy store, a safety mechanism may be provided which is triggered at a particular overpressure. For example, membranes known as bursting membranes are known, and cause at least partial opening of the housing of the electrical energy store at a defined overpressure, and in this way allow gas to escape. This means, however, that the electrical energy store becomes unusable. Moreover, performance may be compromised even before the safety mechanism is triggered.

It is an object of the invention, therefore, to specify a method for producing an electrical energy store that avoids the disadvantages of known energy stores and in particular has a long lifetime. A further object of the invention is to provide an energy store of this kind.

The aforementioned object of the invention is achieved by a method for producing an electrical energy store, comprising steps as follows: first a housing is provided, and at least one positive electrode, comprising a first active material, and at least one negative electrode, comprising a second active material, are introduced into the housing. A gas mixture is then metered into an empty volume of the housing, and the housing is sealed in a gastight manner. The gas mixture comprises at least one component which reacts at least partially with the first and/or second active material after the housing has been sealed.

A basic concept of the invention is to generate a predetermined underpressure within the empty volume of the housing through targeted reaction of the at least one gas component, thereby making it possible to prevent, or at least retard, the development of an unwanted overpressure within the housing during the operation of the electrical energy store. In other words, a pressure buffer is generated for the operation of the electrical energy store.

The underpressure to be established is chosen in particular such that ageing processes of the electrical energy store over its lifetime do not generate a pressure within the housing that exceeds a specified limit.

The limit may be the trigger pressure of a safety mechanism of the electrical energy store, such as of a bursting membrane, for example.

The trigger pressure may also be determined according to a performance parameter of the electrical energy store. This is especially advantageous if, beyond a certain pressure within the housing, deleterious effects in the operation of the electrical energy store may be expected, examples being a loss of capacity, in particular through deposition of lithium on the negative electrode (known as “lithium plating”), and/or an increase in the internal resistance of the electrical energy store.

The empty volume is a volume of the housing in which there are no further, non-gaseous components of the electrical energy store. Such empty volumes are already present in customary designs of electrical energy stores, and so only the gas mixture present in this empty volume need be adapted. It is possible correspondingly for no costly and inconvenient adaptations to the form of the electrical energy store to be necessary.

It has been recognized that the desired underpressure within the housing can be established in a targeted and particularly simple way through the use of at least one gas component which, after the housing has been sealed, reacts automatically with the first and/or second active material to form solids. The term “automatically” in this context means that there is no need for handling of components, by personnel or production apparatuses, for example, in the interior of the cell housing.

In other words, the underpressure which is established in the sealed electrical energy store is defined via the fraction of the at least one gas component that is introduced into the empty volume of the electrical energy store.

Moreover, there is no need for the housing to be sealed under vacuum or for a vacuum to be generated within the housing. It is possible as a result to reduce the complexity and/or the costs of the method of the invention.

The expression “reaction with an active material” here and hereinafter means that the at least one gas component is reacted with constituents of the respective active material and with a component accommodated in the active material and is removed from the gas volume in the energy store. In the case of a lithium-ion battery, for example, the term “reaction with an active material” also includes the reaction of the at least one gas component with lithium ions that are present, more particularly intercalated lithium ions, and/or with lithium, more particularly intercalated lithium, which are/is present in the respective active material.

The empty volume preferably has a size in the range from 5 to 35 percent of the total volume of the housing of the electrical energy store, preferably in the range from 5 to 20 percent.

For example, the empty volume is in the range from 30 mL to 100 mL and the total volume of the housing is in the range from 300 mL to 500 mL. In this way the electrical energy store continues to retain a compact construction.

As a result of the at least partial reaction of the at least one gas component with the first and/or second active material, the first and/or second active material is at least partially consumed and is no longer available for cycling, i.e., for the charging and discharging of the electrical energy store. Accordingly, in particular, the amount of the first and/or second active material in the positive electrode and negative electrode, respectively, is adapted to the fraction of the at least one gas component in the gas mixture, meaning that the electrical energy store also has a desired capacity after reaction of the at least one gas component.

The electrical energy store may be installed with further electrical energy stores to give a storage arrangement in which each electrical energy store takes on the function of a storage cell.

The electrical energy store is more particularly a lithium-ion cell. In that case the storage arrangement is a lithium-ion battery.

The housing is more particularly a prismatic or cylindrical housing.

In one variant, the pressure generated within the empty volume of the housing through reaction of the gas component is 750 mbar or less, preferably a pressure of 700 mbar or less, more preferably of 500 mbar or less, more preferably still a pressure of 300 mbar or less.

An underpressure of this kind within the housing of the electrical energy store provides a sufficient buffer for gases which form during the operation of the electrical energy store, before a critical overpressure forms within the housing, such as an overpressure above the stipulated limit, for example.

The at least one gas component is preferably reacted at least partially to form a passivating layer on the first and/or second active material. It is possible in this way to prevent or at least reduce unwanted secondary reactions, more particularly secondary reactions between the electrolyte and the first and/or second active material. The passivating layer may more particularly be part of an “SEI” (SEI: solid electrolyte interface) on the negative electrode.

The at least one gas component may be reacted with the first and/or second active material during one charging cycle or multiple charging cycles of the electrical energy store. In particular, at least 90 mole percent of the at least one gas component is reacted with the first and/or second active material within the first four charging cycles.

Preferably at least 90 mole percent of the at least one gas component is reacted within the first two charging cycles, more preferably within the first charging cycle.

Where the reaction of the at least one gas component takes place with the second active material, this reaction occurs more particularly during the charging operation within the respective charging cycle of the electrical energy store. Where the reaction of the at least one gas component takes place with the first active material, this reaction takes place more particularly during the discharging operation within the respective charging cycle of the electrical energy store. In both cases, however, a reaction with the other respective active material may additionally take place in parallel as well.

In this way, at the start of the lifetime of the electrical energy store, the pressure within the housing already obtains the desired value, and so the desired protective effect is provided extremely quickly. At the same time, there is no need for an additional production step for reacting the at least one gas component with the first and/or second active material, and so the complexity and/or the costs of the method can be reduced.

During the first charging cycles of an electrical energy store, a multiplicity of reactions occur which lead in particular to the formation of the SEI on the negative electrode. Accordingly, the reaction of the at least one gas component to form a passivating layer may take place together with the formation of the SEI.

It has been recognized that the level of the at least one gas component in the empty volume decreases in particular asymptotically. This means that complete reaction of the at least one gas component is unlikely even over the lifetime of the electrical energy store. Because, however, at least 90 mole percent of the at least one gas component is reacted within the first charging cycles or within the first charging cycle of the electrical energy store, the desired pressure within the housing can be reliably generated and provided in spite of this asymptotic decrease.

The at least one gas component is preferably oxygen.

Oxygen is able to form inert oxides through reaction with the first and/or second active material and so to generate a passivating layer on the respective active material.

In the case of a lithium-ion cell, for example, the oxygen is able to react with lithium present in the second active material, to form lithium oxide.

In this sense, the reaction here between the at least one gas component and the active material likewise encompasses the reaction of the gas component with lithium present and/or taken up in the active material.

Besides the at least one gas component which is reacted with the first and/or second active material, the gas mixture may have further constituents.

The further constituents are, in particular, inert gases, examples being nitrogen and/or noble gases such as argon, crypton and xenon, preferably nitrogen or mixtures of nitrogen and noble gases.

The gas mixture in particular has a very low residual moisture content, so as not to generate any unwanted reactions with the first and/or second active material and/or with the electrolyte.

The at least one gas component is present in particular in a fraction of at least 25 volume percent in the gas mixture, preferably in a fraction of at least 30 or 35 volume percent, more preferably of at least 50 or 55 volume percent, more preferably still in a fraction of at least 70 or 75 volume percent.

The fraction of the at least one gas component in the gas mixture is tailored to the underpressure to be established within the housing and/or to the expected reaction behavior, in particular the reaction kinetics and the reaction products generated, of the at least one gas component during the reaction with the first and/or second active material.

The first active material may in principle be any active material known for positive electrodes in the prior art.

In the case of a lithium-ion cell, such material includes, for example, LiCoO₂, lithium-nickel-cobalt-manganese compounds (known by the abbreviation NCM or NMC), lithium nickel cobalt aluminum oxide (NCA), lithium iron phosphate and other olivine compounds, and lithium manganese oxide spinel (LMO). Over-lithiated layered oxides (OLO) may also be used.

The first active material may also contain mixtures of two or more of the stated compounds.

The gas component is preferably reacted with the second active material.

The second active material may be selected from the group consisting of carbon-containing materials, silicon, silicon suboxide, silicon alloys, and mixtures thereof.

The second active material is preferably selected from the group consisting of synthetic graphite, natural graphite, graphene, mesocarbon, doped carbon, hard carbon, soft carbon, fullerene, silicon-carbon composite, silicon, surface-coated silicon, silicon suboxide, silicon alloys, and mixtures thereof.

The first and/or second active material may comprise further additives, of the kind known in the prior art, examples being conductivity modifiers for increasing the electrical conductivity.

The object of the invention is additionally achieved by an electrical energy store produced by the method described above.

In particular, the electrical energy store has an empty volume within the housing of the electrical energy store that has a size in the range from 5 to 35 percent of the total volume of the housing, preferably in the range from 5 to 20 percent.

For example, the empty volume is in the range from 30 mL to 100 mL and the total volume of the housing is in the range from 300 mL to 500 mL.

The pressure within the empty volume of the housing of the electrical energy store is, in particular, 750 mbar or less, preferably 700 mbar or less, more preferably 500 mbar or less, more preferably still 300 mbar or less.

The housing of the electrical energy store is preferably a prismatic housing or a round housing.

The housing of the electrical energy store is made in particular of stainless steel or aluminum. The housing may have a nickel coating.

If the housing is a prismatic housing, it is preferably made of aluminum. If the housing is a round housing, it is preferably made of nickel-coated stainless steel.

Further advantages and properties of the invention are apparent from the description hereinafter of illustrative embodiments, which are to be understood not in a limiting sense, and also from the drawings.

### BRIEF DESCRIPTION OF THE DRAWINGS

FIG. 1 shows a schematic cross-sectional view through an electrical energy store of the invention, and

FIG. 2 shows a block diagram of the method of the invention producing an electrical energy store according to FIG. 1.

### DETAILED DESCRIPTION OF THE DRAWINGS

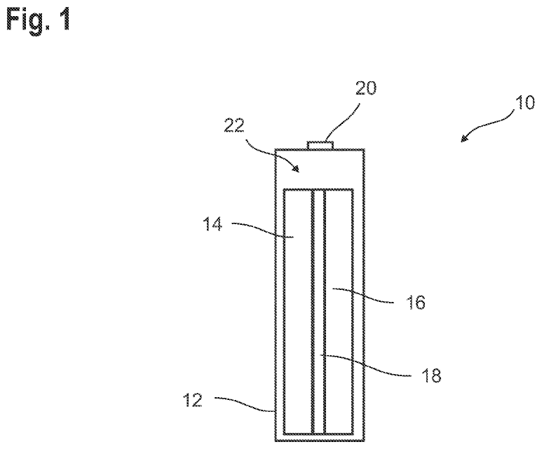

FIG. 1 shows an electrical energy store 10 of the invention, which has a housing 12.

The housing 12 is a prismatic housing and is made of aluminum.

In principle the housing 12 could also be a cylindrical housing (also referred to as a round housing) and/or could consist of other materials of the kind known in the prior art.

Disposed within the housing are a positive electrode 14 (also termed cathode) and a negative electrode 16 (also termed anode) which are spaced apart from one another and electrically insulated from one another by a separator 18.

In principle it is also possible to provide a multiplicity of positive electrodes 14 and a multiplicity of negative electrodes 16, each spaced apart from one another and electrically insulated from one another by a separator 18.

The positive electrode 14 has a first active material, and the negative electrode 16 has a second active material.

The first active material is, for example, NMC811 (LiNi_{0.8}Mn_{0.1}Co_{0.1}O₂) and the second active material is, for example, natural graphite. In the embodiment of the electrical energy store 10 that is shown, accordingly, the store is a lithium-ion cell.

In principle, however, all of the active materials known from the prior art could be employed.

The positive electrode 14, the negative electrode 16, and the separator 18 are impregnated with an electrolyte which is ion-conducting, more particularly being conducting for lithium ions, and which comprises a solvent and also a conductive salt, more particularly a conductive lithium salt, an example being lithium hexafluorophosphate (LiPF₆).

The positive electrode 14 and the negative electrode 16 are each connected electrically to an assigned electrical contact 20 of the electrical energy store 10, the contacts 20 being disposed on an outer side of the housing 12. Consumer units can be attached to the electrical energy store 10 via the electrical contacts 20.

Provided within the housing 12 is an empty volume 22 in which there are no solid or liquid components of the electrical energy store 10 disposed, there being instead only gaseous components present.

The empty volume 22 is in the range from 30 mL to 100 mL, for example 80 mL, whereas the total volume of the housing 12 is in the range from 300 mL to 500 mL.

The pressure prevailing within the housing 21 is 750 mbar or less, preferably 700 mbar or less, more preferably 500 mbar or less, more preferably still 300 mbar or less.

During the operation of the electrical energy store 10, therefore, gases may be formed, by partial decomposition of the electrolyte, for example, and may enter the empty volume 22, before an overpressure, referring to a pressure of greater than 1 bar, is built up within the housing 12.

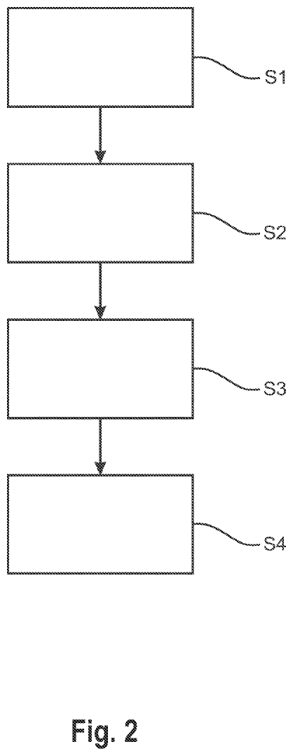

FIG. 2 shows a block diagram of a method of the invention for producing the electrical energy store 10.

The method of the invention comprises steps as follows.

First the housing 12 is provided (step S1). Subsequently, the positive electrode 14, comprising the first active material, and the negative electrode 16, comprising the second active material, are introduced into the housing 12 (step S2).

Moreover, the separator 18 is disposed between the positive electrode 14 and the negative electrode 16.

Alternatively, it is also possible first to produce a stack of the positive electrode 14, the separator 18, and the negative electrode 16, and to introduce this stack as a whole into the housing 12.

Subsequently, an electrolyte is filled into the housing 12 to wet the positive electrode 14, the negative electrode 16, and the separator 18.

After that, a gas mixture is filled into the empty volume 22 of the housing 12 (step S3) and the housing 12 is sealed in a gastight manner (step S4), by welding, for example.

Before the gas mixture is filled into the empty volume 22 (step S3), the electrical energy store 10 may undergo a preliminary charging cycle. The gases which form in this cycle may subsequently be displaced by the gas mixture and the housing 12 may subsequently be sealed (step S4). In this way it is possible to prevent gases formed during the preliminary charging cycle of the electrical energy store 10, which would otherwise form during the first charging cycle after the housing 12 is sealed, from undoing at least part of the desired underpressure within the housing 12.

The gas mixture comprises at least one gas component which is at least partially reacted with the first and/or second active material and in this way generates a predetermined underpressure within the housing 12.

The at least one gas component is present in a fraction of at least 25 volume percent of the gas mixture, preferably in a fraction of at least 30 or 35 volume percent, more preferably of at least 50 or 55 volume percent, more preferably still in a fraction of at least 70 or 75 volume percent.

In the case of virtually complete reaction of the at least one gas component with a fraction of 25 volume percent in the gas mixture, for example, a pressure of about 750 mbar may be generated within the housing 12.

In the embodiment shown, the gas component is oxygen. Nitrogen as inert gas is used as a further constituent of the gas mixture.

As soon as the electrical energy store 10 produced by means of the method of the invention undergoes one or more charging cycles, hence being charged and discharged, the oxygen in the gas mixture reacts with the lithium present or taken up in the second active material of a negative electrode 16 to form lithium oxide and in this way is consumed and removed from the gas volume.

The amount of second active material is adapted to the amount of oxygen used in the gas mixture in such a way that the electrical energy store 10 still has a desired capacity after reaction of the oxygen.

For this purpose, for each milliliter of oxygen in the empty volume, an additional amount of second active material is used corresponding to a resulting capacity of 4 mAh.

In particular, at least 90 mole percent of the oxygen present within the empty volume 22 is reacted within the first four charging cycles of the electrical energy store 10, preferably within the first two charging cycles, more preferably within the first charging cycle.

Accordingly, the pressure within the housing 12 drops to the desired value right at the start of the lifetime of the electrical energy store 10, hence making it possible to effectively prohibit an overpressure within the housing 12, even in the event of gaseous decomposition products of the constituents of the electrical energy store 10 forming over the lifetime of the electrical energy store 10.

1.-10. (canceled)

11. A method for producing an electrical energy store, the method comprising:
providing a housing;
introducing at least one positive electrode, including a first active material, and at least one negative electrode, including a second active material, into the housing;
metering a gas mixture into an empty volume of the housing; and
sealing the housing in a gastight manner;
wherein the gas mixture comprises at least one gas component which is reacted at least partially with at least one of the first active material and the second active material after the housing has been sealed.

12. The method according to claim 11, wherein reaction of the gas component within the empty volume of the housing generates a pressure of 750 mbar or less.

13. The method according to claim 12, wherein reaction of the gas component within the empty volume of the housing generates a pressure of 700 mbar or less.

14. The method according to claim 13, wherein reaction of the gas component within the empty volume of the housing generates a pressure of 500 mbar or less.

15. The method according to claim 14, wherein reaction of the gas component within the empty volume of the housing generates a pressure of 300 mbar or less.

16. The method according to claim 11, wherein the at least one gas component is reacted at least partially to give a passivating layer on at least one of the first active material and the second active material.

17. The method according to claim 11, wherein the gas component is reacted with at least one of the first active material and the second active material during one charging cycle or multiple charging cycles of the electrical energy store, in that at least 90 mole percent of the at least one gas component is reacted with at least one of the first active material and the second active material within the first four charging cycles.

18. The method according to claim 11, wherein the at least one gas component is oxygen.

19. The method according to claim 11, wherein the at least one gas component is present in a fraction of at least 25 volume percent in the gas mixture.

20. The method according to claim 19, wherein the at least one gas component is present in a fraction of at least 35 volume percent.

21. The method according to claim 20, wherein the at least one gas component is present in a fraction of at least 55 volume percent.

22. The method according to claim 21, wherein the at least one gas component is present in a fraction of at least 75 volume percent.

23. The method according to claim 11, wherein the gas component is reacted with the second active material.

24. The method according to claim 11, wherein the second active material is selected from the group consisting of carbon-containing materials, silicon, silicon suboxide, silicon alloys, and mixtures thereof.

25. An electrical energy store produced by a method according to claim 11.

26. The electrical energy store according to claim 25, wherein the housing is a prismatic housing or a round housing.
